(19) United States
(12) Patent Application Publication
(10) Pub. No.: US 2020/0342160 A1
(43) Pub. Date: Oct. 29, 2020

(54) SCRIPT CREATION SYSTEM

(71) Applicants: Denise Hewett, Los Angeles, CA (US); Eugene Hauptmann, Hawthorne, CA (US)

(72) Inventors: Denise Hewett, Los Angeles, CA (US); Eugene Hauptmann, Hawthorne, CA (US)

(21) Appl. No.: 16/862,205

(22) Filed: Apr. 29, 2020

Related U.S. Application Data
(60) Provisional application No. 62/840,303, filed on Apr. 29, 2019.

(51) Int. Cl. G06F 40/103; G06F 16/14; G06F 16/13; G06F 16/11; G06T 11/60; G06F 40/30

(52) U.S. Cl. CPC G06F 40/103; G06F 16/148; G06F 40/30; G06F 16/116; G06T 11/60; G06F 16/13

(57) ABSTRACT

Systems and methods for script creation are provided. In one aspect, a script creation system may receive an electronic script file, identify a plurality of script categories, identify a coordinate location for each character in the electronic script file, determine a script category for each character, assign a display format for each character, generate a smart script based at least in part on the display format, and transmit the smart script to a user computing device.

### BACKGROUND OF THE INVENTION

Professionals rely on scripts to create movies, shows, acts, or plays. For example, actors must carefully read a script in order to learn their roles and lines in a movie. Writers are interested in creating scripts that a reader will be able to easily refer to and digest and may use specific formats to organize information such as location, exposition, characters, speech, and dialogue order. However, because scripts are often produced as pages upon pages of plain text on paper, a reader may have difficulty utilizing the script as the complexity and length of the script increases. Thus, a writer, director, actor, or consumer may be interested in transforming a traditional paper script into a smart script in order to improve a reader's ability to easily access, understand, and use a script.

### SUMMARY OF SOME EMBODIMENTS

One embodiment includes a system comprising: a non-transitory computer-readable storage medium storing computer-executable instructions; and one or more hardware processors in communication with the computer-readable memory, wherein the executable instructions, when executed by the one or more hardware processors, cause the one or more hardware processors to at least: receive an electronic script file, wherein the electronic script file comprises a plurality of characters; identify a plurality of script categories; identify a coordinate location for each character in the electronic script file; determine a script category for each character based at least in part on the coordinate location associated with each character; assign a display format for each character, wherein the display format is based at least in part on the script category; generate a smart script based at least in part on the display format; and transmit the smart script to a user computing device.

Various embodiments of the system may include one, all, or any combination of the following features. In some embodiments, the plurality of script categories comprises dialogue, speech, exposition, and location categories. In some embodiments, the electronic script file is stored in a searchable electronic format. In some embodiments, each page of the electronic script file is associated with an x-y coordinate system. In some embodiments, the top-left corner of each page of the electronic script file is associated with a (0, 0) x-y coordinate location. In some embodiments, the coordinate location for each character in the electronic script file comprises a unique coordinate in an x-y coordinate system. In some embodiments, the script category for each character is further determined based at least in part on the identity of the character and a specific sequence of characters. In some embodiments, the display format for each character comprises an image associated with the script category for the character. In some embodiments, the display format for each character is based at least in part on the coordinate location and the script category associated with the character. In some embodiments, the smart script displays text according to the coordinate location associated with each character and generates images associated with text.

Another embodiment includes a computer-implemented method comprising: under control of one or more computing devices executing specific computer-executable instructions, receiving an electronic script file, wherein the electronic script file comprises a plurality of characters; identifying a plurality of script categories; identifying a coordinate location for each character in the electronic script file; determining a script category for each character based at least in part on the coordinate location associated with each character; assigning a display format for each character, wherein the display format is based at least in part on the script category; generating a smart script based at least in part on the display format; and transmitting the smart script to a user computing device.

Various embodiments of the method may include one, all, or any combination of the following features. In some embodiments, the plurality of script categories comprises dialogue, speech, exposition, and location categories. In some embodiments, the electronic script file is stored in a searchable electronic format. In some embodiments, each page of the electronic script file is associated with an x-y coordinate system. In some embodiments, the top-left corner of each page of the electronic script file is associated with a (0, 0) x-y coordinate location. In some embodiments, the coordinate location for each character in the electronic script file comprises a unique coordinate in an x-y coordinate system. In some embodiments, determining the script category for each character is based at least in part on the identity of the character and a specific sequence of characters. In some embodiments, the display format for each character comprises an image associated with the script category for the character. In some embodiments, the display format for each character is based at least in part on the coordinate location and the script category associated with the character. In some embodiments, the smart script displays text according to the coordinate location associated with each character and generates images associated with text.

### BRIEF DESCRIPTION OF THE DRAWINGS

Throughout the drawings, reference numbers are re-used to indicate correspondence between referenced elements. The drawings are provided to illustrate embodiments of the subject matter described herein and not to limit the scope thereof.

FIG. 1 is a block diagram illustrating an example computing environment for a script creation system, according to some embodiments.

FIG. 2 illustrates example script categories utilized by the script creation system of FIG. 1.

FIG. 3 illustrates an example script page parsed into script components, according to some embodiments.

FIG. 4 is example computer code implementing the script creation method described herein, according to some embodiments.

FIG. 5 is an example user interface displaying an example smart script, according to some embodiments.

FIG. 6 is a flow diagram illustrating an example script creation method, according to some embodiments.

FIG. 7 is a block diagram of an example computing system configured to implement the verbal expression system described herein, according to some embodiments.

### DETAILED DESCRIPTION

As described above, an actor, director, writer, or consumer may be interested in generating scripts that are easy to read and understand. For years, such professionals have used paper scripts. For example, a director may distribute a physical script book to all actors participating in a movie. In particular, one section of the script book may include exposition text that sets the necessary background for a scene, while another section of the script book may include a movie character's dialogue in a specific scene. Thus, an actor may browse the section of a script corresponding to the actor's role to learn the actor's lines and scene information.

Typically, however, directors are interested in having readers review and memorize the script in as little time as possible. Because the scripts described above are formatted as plain text on paper in a large book, the paper scripts provide no mechanism for an actor to easily search for and identify areas of the script that pertain to the particular actor. Even though scripts may display some form of organizational structure (e.g., by using headers or line breaks), the script may still be unwieldy as the complexity and length of the script increases. Furthermore, as a practical matter, it is costly to reproduce and distribute many physical copies of a script.

In fact, it would still be impractical for a writer, actor, director, and/or other user to use traditional scripts even if such scripts are converted into a searchable electronic format (e.g., a text file or a PDF file). For example, the electronic script may be organized in a structure that mirrors the structure of the above-described script books. An actor may be able to navigate to a particular page in the script that identifies the actor's lines for a scene, but the actor would still face the same difficulties in quickly identifying and digesting information as described above because the electronic version still displays information in the same way as on the paper version.

Accordingly, described herein is a script creation system that allows actors and/or any other user to transform a traditional script into a smart script to help readers and users identify quickly portions of a script containing information useful to the actor and/or the user. The script creation system implements operations that previously could not be performed manually or using a computing system at least for the reasons described above.

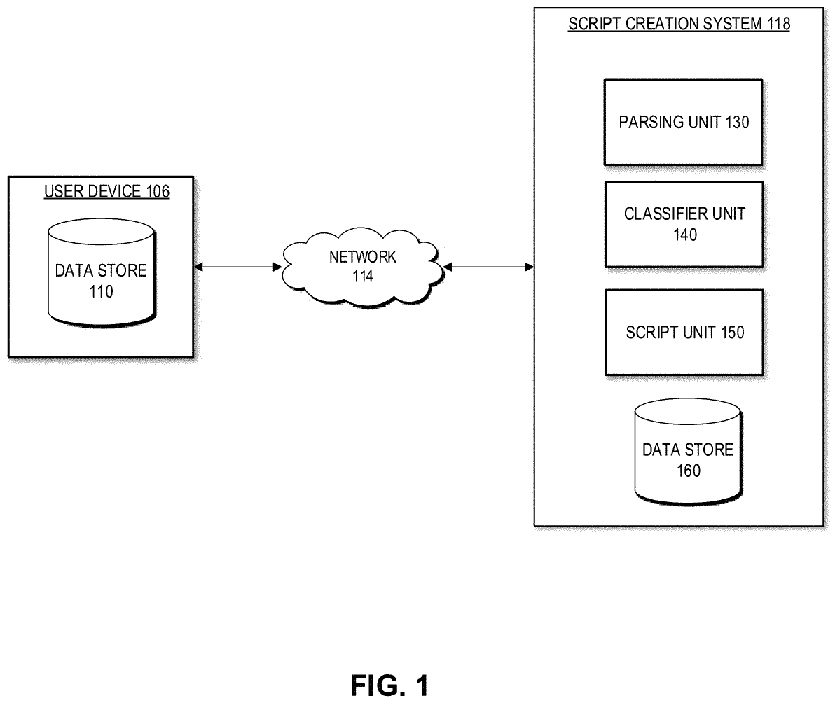

FIG. 1 is a block diagram illustrating an example computing environment for a script creation system 118. The illustrative environment includes a user device 106, a network 114, and the script creation system 118. In some embodiments, user device 106 may be any computing device such as a desktop, laptop or tablet computer, personal computer, wearable computer, server, personal digital assistant (PDA), hybrid PDA/mobile phone, mobile phone, electronic book reader, voice command device, camera, digital media player, and/or the like. While FIG. 1 illustrates a single user device 106, this is not meant to be limiting. Any number of user devices 106 may each be used by any number of different users (e.g., screenwriters, directors, etc.) to access and/or to interact with the script creation system 118. In some embodiments, the user device 106 may receive one or more files from the script creation system 118 over network 114 and store the received files in data store 110. For example, the user device 106 may receive a smart script file from the script creation system 118. Data store 110 may also store electronic script files to transmit to the script creation system 118 to create a smart script utilizing the script creation method described herein.

In some embodiments, script creation system 118 may include a parsing unit 130, a classifier unit 140, a script unit 150, and a data store 160. The data store 160 may store a plurality of script files, such as script files generated by the script creation system 118. For example, the data store 160 may be a database, where each database entry is a script file associated with one or more movies, plays, acts, and/or other types of shows. Each entry in the database may be associated with metadata identifying a title, one or more categories, an address, description, tag, pointer, and/or numerical value of the corresponding video file. For example, a script file may be associated with the numerical value “5” to indicate that the script file corresponds to an enumerated category (e.g., comedy).

The script creation system 118 may receive, from a user device 106, an electronic copy of a script and may utilize parsing unit 130 to analyze the content and format of the script. As will be discussed later, the parsing unit 130 may determine an x-y coordinate system for each page of the script (e.g., wherein (0, 0) corresponds to the top-left corner of the page) and identify the x and y coordinates for each character on a page. For purposes of clarity, the following description will assume an x-y coordinate system wherein the top-left corner of the page corresponds with a (0, 0) coordinate. However, it will be appreciated that other x-y schemes may be utilized in other embodiments. By identifying the x and y coordinates for each character, the parsing unit 130 may advantageously track the specific sequence of characters as they appear on the page of the script. In some embodiments, the parsing unit 130 may also identify the particular character itself. For example, the parsing unit 130 may identify that the character associated with the x-y coordinate of (1, 1) is “s,” the character associated with the x-y coordinate of (2, 1) is “i,” the character associated with the x-y coordinate of (3, 1) is “t.”

In some embodiments, the classifier unit 140 may automatically associate a plurality of characters with a script component. The script creation system 118 may store a list of script components in data store 160. For example, the script creation system 118 may store script components corresponding to the categories “Exposition,” “Speaker,” “Speech,” and “Location,” wherein every instance of text in the script may be associated with one of the script component categories. The classifier unit 140 may associate a particular script component to a character or group of characters based at least in part on the x-y coordinates of the character or group of characters. For example, the classifier unit 140 may automatically assign each character with an x-coordinate of “6” as “Speech” because all speech and dialogue text in the script are aligned so that every line of dialogue begins at x-coordinate 6. In some embodiments, the classifier unit 140 may also assign a script component based at least in part on the x-y coordinate of a character and the identity of the character itself. For example, the classifier unit 140 may identify that a string or array of characters begins at the x-y coordinate (1, 1) and that the string of characters includes the characters “I,” “N,” “T,” and “.” in that specific order, wherein “I” has the x-y coordinate (1, 1), “N” has the x-y coordinate (2, 1), “T” has the x-y coordinate (3, 1), and “.” has the x-y coordinate (4, 1). The classifier unit 140 may associate the string of characters with the “Location” script component because the string of characters begins at an x-coordinate of 1 and contains “INT.” It will be appreciated that other keywords may be utilized in other embodiments to identify specific components in a script (e.g., “EXT.” to indicate a “Location” component).

The classifier unit 140 may also consider the specific sequence of characters when assigning a script component. For example, in some embodiments, the classifier unit 140 may assign a “Speaker” component to a string that is center justified and comprises an empty line character, followed by a line with text, followed by an empty line character in that specific order. In some embodiments, the classification may also depend on a character length value. For example, with reference to the above example, the classifier unit 140 may assign a “Speaker” component to the string only if the total character length of the string is less than 20 characters.

In some embodiments, the classification of characters may depend on previously-identified classifications. For example, if a particular portion of alphanumeric text is associated with the “Speaker” component, then the classifier unit 140 may associate the text below that portion with a “Speech” script component. Similarly, the classifier unit 140 may determine that a portion of text should no longer be associated with a “Speech” component if the script creation system 118 identifies a particular keyword or character in a specific x-y coordinate further down the page (e.g., the script creation system 118 identifies the keyword “INT.” and therefore stops associating the text with the “Speech” component).

After the script creation system 118 parses the script and associates each portion of text with a category, component, or classification, the script unit 150 may generate a smart script to be displayed to a user. As will be discussed later, the script unit 150 may generate a user interface displaying the script in a smart script format. In some embodiments, the smart script format may display portions of text according to the x-y coordinates of characters identified by the parsing unit 130. For example, if a first line of exposition has a y-coordinate of 5 and a second line of exposition has a y-coordinate of 10, then the script unit 150 may display the first line of exposition before the second line of exposition. In some embodiments, the script unit 150 may generate images associated with a portion of text based at least in part on the classification, category, or component of the portion of text. For example, if a portion of text is associated with a “Speaker” classification, then the script unit 150 may couple the identified text with an image of a speaker. The image may be chosen depending on the particular arrangement of characters associated with the “Speaker” classification. For example, if the text “Bob” is associated with the “Speaker” component, then the script unit 150 may associate “Bob” with an image of Bob. Thus, each time “Bob” appears in the original script, the script unit 150 may display the text alongside the image of Bob. In contrast, the script unit 150 may associate an entirely different image to the text portion “Sally” even if “Sally” is associated with a “Speaker” classification. In some embodiments, the script unit 150 may also assign a specific color to each string of characters associated with a “Speaker” classification. For example, with reference to the above example, the script unit 150 may assign “Bob” with the color blue while the script unit 150 may assign “Sally” with the color orange. Advantageously, the script creation system 118 may display the name of the speaker alongside the speaker's associated image and color to allow a reader to quickly and easily search for and identify a particular speaker's lines. It will be appreciated that the script unit 150 may also assign and display images or formats for other script components or categories. For example, the script unit 150 may display all “Speech” text as a text box with borders displaying the color associated with the particular speaker.

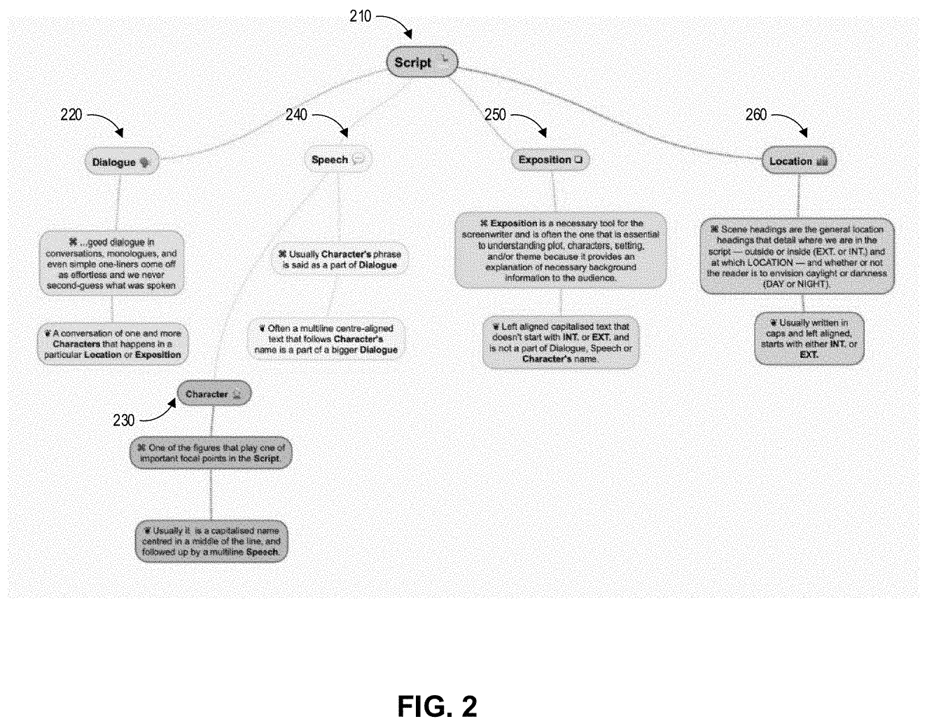

FIG. 2 illustrates example script categories utilized by the script creation system of FIG. 1. Script 210 comprises alphanumeric text that may be divided into categories 220, 230, 240, 250, and 260. In some embodiments, each category corresponds to a specific type of information displayed in a script. For example, category 220 is applied to alphanumeric text in a script to identify a conversation of one or more characters that occurs in a particular location, environment, or exposition. Category 230 may be associated with a particular portion of text in the script in order to identify specific speakers, characters, or figures in the script. Category 240 may be applied to portions of the script to identify a particular speaker's lines or conversation. Category 250 may correspond to portions of the script dedicated to necessary background information for the reader that may be essential to understanding the plot, characters, settings, or themes of the script (e.g., a description of an object in the scene, a character's physical gestures during a conversation, etc.). Category 260 may be associated with text identifying general location information (e.g., inside or outside) and environment information (e.g., heavy wind, night time). In some embodiments, text associated with category 240 may also be associated with category 220 because a specific character's speech may be a part of a broader conversation with other characters.

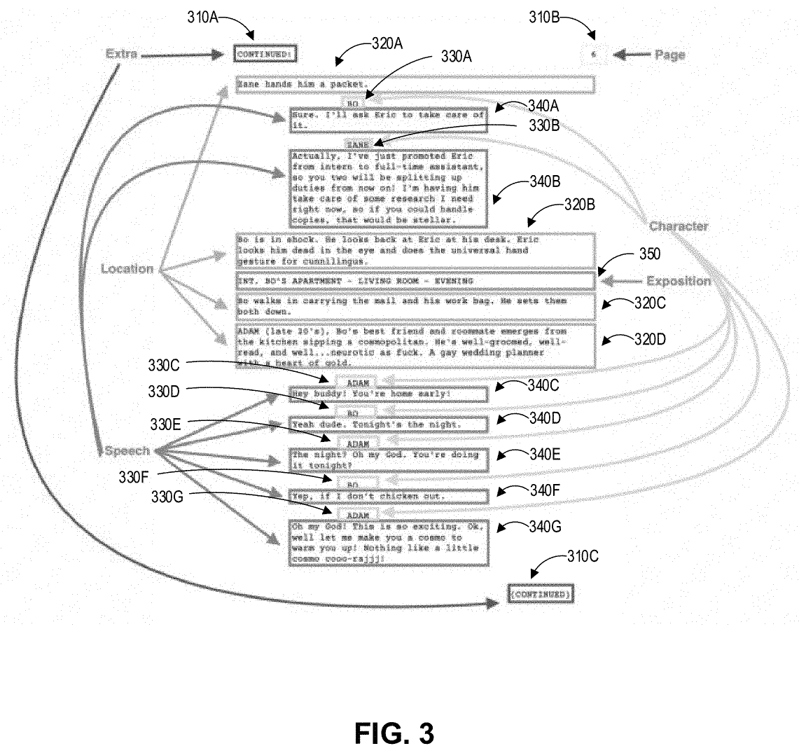

FIG. 3 illustrates an example script page parsed into script components, according to some embodiments. The example script page includes blocks 310A-C, blocks 320A-D, blocks 330A-G, blocks 340A-G, and block 350. As discussed earlier, the script creation system 118 may associate portions of text with a script component, category, or classification based at least in part on the x-y coordinates of characters, the identity of the characters themselves, keywords, and/or previous classifications identified in the script. Script creation system 118 may assign blocks 310A-C with the “Extra” category because Blocks 310A-C each have a y-coordinate above or below a certain threshold. For example, in some embodiments, scripts may only display miscellaneous information on the outer perimeter of the page. Therefore, if the x-y coordinate system ranges from 0 to 100 units in the y direction, then the script creation system 118 may automatically associate any strings of characters with an “Extra” or “Miscellaneous” category if the y-coordinate of the characters is below 2 or above 98.

The script creation system 118 may similarly assign other categories to portions of script text. For example, blocks 320A-D may be associated with an “Exposition” category by identifying that blocks 320A-D begin with a character having an x-coordinate of 2 and that blocks 320A-D do not contain a specific keyword (e.g., INT. or EXT.). The script creation system 118 may assign blocks 330A-G with a “Speaker” or “Character” category by detecting that the string of text is center justified and comprises an empty line character, followed by a line with text, followed by an empty line character in that specific order. In some embodiments, the classification may also depend on a character length value. For example, with reference to the above example, the script creation system 118 may assign the “Speaker” category to the string only if the total character length of the string is less than 20 characters.

In some embodiments, the classification of characters may depend on previously-identified classifications. For example, if a particular portion of alphanumeric text is associated with the “Speaker” component, then the script creation system 118 may associate the text below that portion with a “Speech” script component. Similarly, the script creation system 118 may determine that a portion of text should no longer be associated with a “Speech” component if the script creation system 118 identifies a particular keyword or character in a specific x-y coordinate further down the page (e.g., the script creation system 118 identifies the keyword “INT.” and therefore stops associating the text with the “Speech” component). Script creation system 118 may assign block 350 the “Location” category by identifying the keyword “INT.”

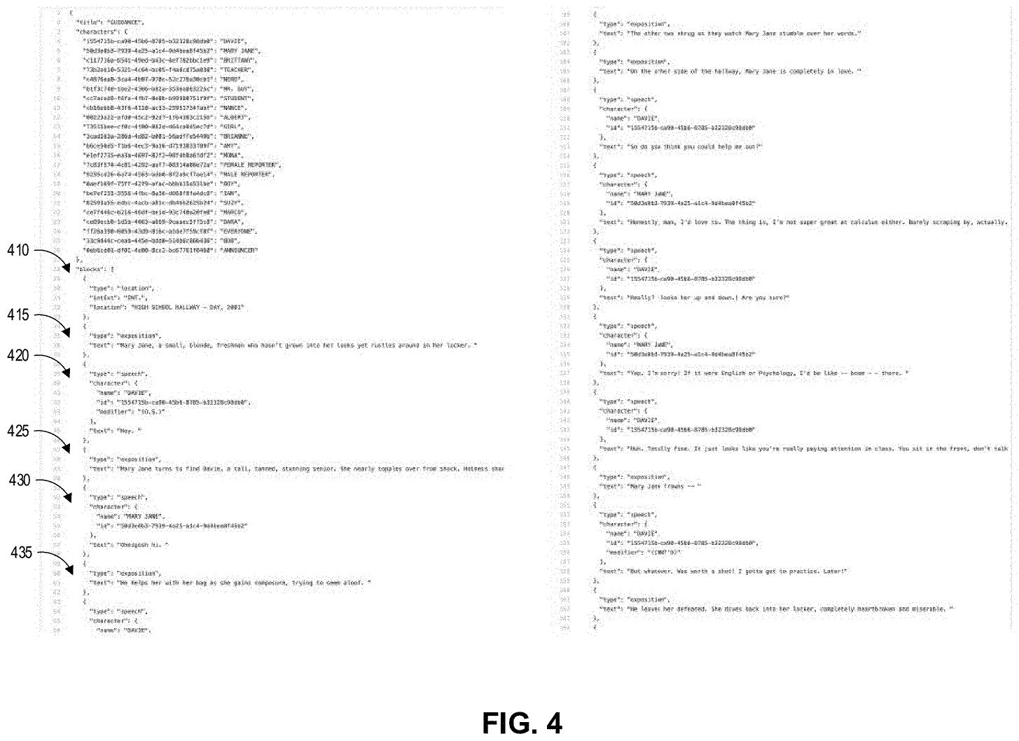

FIG. 4 is example computer code implementing the script creation method described herein, according to some embodiments. Blocks 410, 415, 420, 425, 430, and 435 illustrate the categorization of blocks of text. Blocks 410 through 435 each assign a category or script component to a line of text. In some embodiments, the computer code may explicitly assign keywords to a line of text to help identify the category of the text. For example, the computer code at block 410 explicitly assigns the text “HIGH SCHOOL HALLWAY—DAY, 2001” with the keyword “INT.,” signifying that the text should be associated with a “Location” category. Similarly, the code in block 420 assigns the text “Hey.” to a specific character named “DAVIE” and a category “speech.”

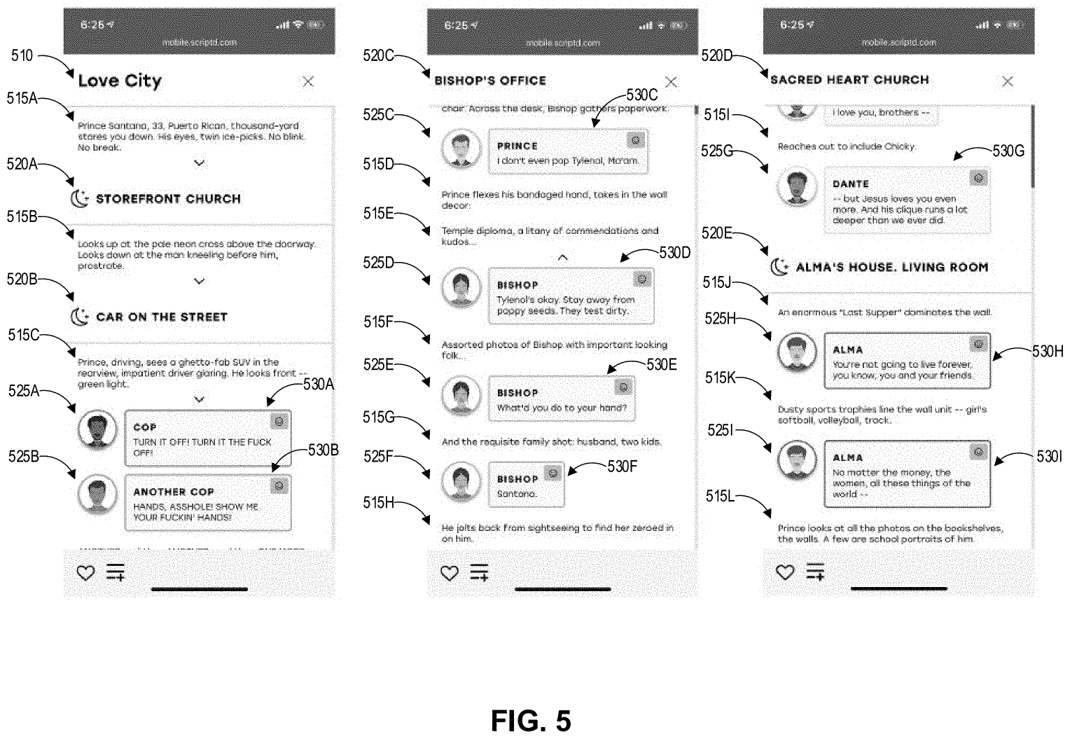

FIG. 5 is an example user interface displaying an example smart script, according to some embodiments. The script creation system 118 may display the title of a particular movie, act, or play in block 510. The script creation system 118 may display script text associated with an “exposition” classification in blocks 515A-L and text associated with a “location” classification in blocks 520A-E. Advantageously, image 525A may be displayed alongside speech 530A to allow a reader to quickly visualize and identify the speaker and the speaker's lines in the script. Similarly, the script creation system 118 may display image 525B alongside speech 530B, wherein image 525B is the image of the specific speaker associated with speech 530B. To further provide help a reader's ability to quickly search for and identify relevant lines in a script, the script creation system 118 may also associate each speaker and speech with a color unique to the speaker. For example, the script creation system 118 may display the color purple on the borders of image 525 and speech 530A while the system 118 may display an orange border around image 525B and speech 530B to indicate that the speaker associated with image 525A and speech 530A is different than the speaker associated with image 525B and speech 530B. The script creation system 118 may display all blocks according to the sequential order of blocks in the original script. For example, the script creation system 118 may display speech 530B immediately after 530A because that is the specific sequential order of speeches identified in the original script.

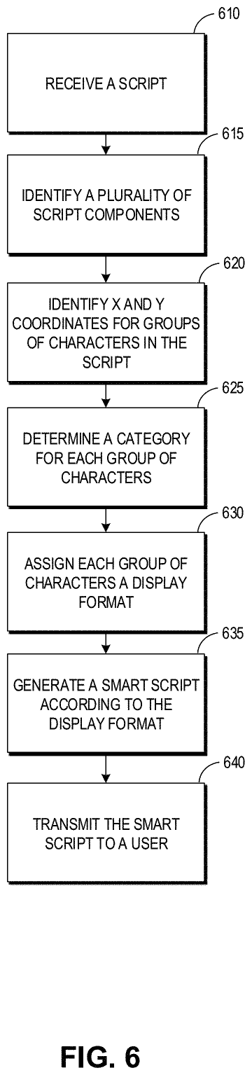

FIG. 6 is a flow diagram of an example script creation method. The example script creation method may be implemented by the script creation system 118.

At block 610, the script creation system 118 may receive an electronic script. In some embodiments, the script creation system 118 may receive, from a user device 106, an electronic copy of a script. At block 615, the script creation system 118 may identify a plurality of script components or categories. In some embodiments, the script creation system 118 may determine script categories by referring to data store 160, wherein the data store 160 may comprise an array of script categories. For example, data store 160 may include as a data entry an array comprising [“location”, “exposition”, “character”. “speech”, “dialogue”, “extra”].

At block 620, the script creation system 118 may identify x and y coordinates for groups of characters in the script. In some embodiments the script creation system 118 may do so by utilizing parsing unit 130 to analyze the content and format of the script. The parsing unit 130 may determine an x-y coordinate system for each page of the script (e.g., wherein (0, 0) corresponds to the top-left corner of the page) and identify the x and y coordinates for each character on a page. By identifying the x and y coordinates for each character, the parsing unit 130 may advantageously track the specific sequence of characters as they appear on the page of the script. In some embodiments, the parsing unit 130 may also identify the particular character itself. For example, the parsing unit 130 may identify that the character associated with the x-y coordinate of (1, 1) is “s,” the character associated with the x-y coordinate of (2, 1) is “i,” the character associated with the x-y coordinate of (3, 1) is “t.”

At block 625, the script creation system 118 may determine a script component for each group of characters. In some embodiments, the classifier unit 140 may automatically associate a plurality of characters with a category. The classifier unit 140 may associate a particular script category to a character or group of characters based at least in part on the x-y coordinates of the character or group of characters. For example, the classifier unit 140 may automatically assign each character with an x-coordinate of “6” the category “Speech” because all speech and dialogue text in the script may be aligned so that every line of dialogue begins at x-coordinate 6. In some embodiments, the classifier unit 140 may also assign a script component based at least in part on the x-y coordinate of a character and the identity of the character itself. For example, the classifier unit 140 may identify that a string or array of characters begins at the x-y coordinate (1, 1) and that the string of characters includes the characters “I,” “N,” “T,” and “.” in that specific order, wherein “I” has the x-y coordinate (1, 1), “N” has the x-y coordinate (2, 1), “T” has the x-y coordinate (3, 1), and “.” has the x-y coordinate (4, 1). The classifier unit 140 may associate the string of characters with the “Location” script component because the string of characters begins at an x-coordinate of 1 and contains “INT.” It will be appreciated that other keywords may be utilized in other embodiments to identify specific components in a script (e.g., “EXT.” to indicate a “Location” component).

The classifier unit 140 may also consider the specific sequence of characters when assigning a script component. For example, in some embodiments, the classifier unit 140 may assign a “Speaker” component to a string that is center justified and comprises an empty line character, followed by a line with text, followed by an empty line character in that specific order. In some embodiments, the classification may also depend on a character length value. For example, with reference to the above example, the classifier unit 140 may assign a “Speaker” component to the string only if the total character length of the string is less than 20 characters.

In some embodiments, the classification of characters may depend on previously-identified classifications. For example, if a particular portion of alphanumeric text is associated with the “Speaker” component, then the classifier unit 140 may associate the text below that portion with a “Speech” script component. Similarly, the classifier unit 140 may determine that a portion of text should no longer be associated with a “Speech” component if the script creation system 118 identifies a particular keyword or character in a specific x-y coordinate further down the page (e.g., the script creation system 118 identifies the keyword “INT.” and therefore stops associating the text with the “Speech” component).

At block 630, the script creation system 118 may assign each group of characters a display format. In some embodiments, the display format for each group of characters may be based at least in part on the identified x-y coordinates or the category associated with the group of characters. For example, if a first line of exposition has a y-coordinate of 5 and a second line of exposition has a y-coordinate of 10, then the script creation system 118 may display the first line of exposition before the second line of exposition. In some embodiments, the script creation system 118 may generate images associated with a portion of text based at least in part on the classification, category, or component of the portion of text. For example, if a portion of text is associated with a “Speaker” classification, then the script creation system 118 may couple the identified text with an image of a speaker. The image may be chosen depending on the particular arrangement of characters associated with the “Speaker” classification. For example, if the text “Bob” is associated with the “Speaker” component, then the script creation system 118 may associate “Bob” with an image of Bob. Thus, each time “Bob” appears in the original script, the script creation system 118 may display the text alongside the image of Bob. In contrast, the script creation system 118 may associate an entirely different image to the text portion “Sally” even if “Sally” is associated with a “Speaker” classification. In some embodiments, the script creation system 118 may also assign a specific color to each string of characters associated with a “Speaker” classification. For example, with reference to the above example, the script creation system 118 may assign “Bob” with the color blue while the script creation system 118 may assign “Sally” with the color orange. Advantageously, the script creation system 118 may display the name of the speaker alongside the speaker's associated image and color to allow a reader to quickly and easily search for and identify a particular speaker's lines. It will be appreciated that the script creation system 118 may also assign and display images or formats for other script components or categories. For example, the script creation system 118 may display all “Speech” text as a text box with borders displaying the color associated with the particular speaker. At block 635, the script creation system 118 may generate a smart script according to the display format. At block 640, the script creation system 118 may transmit the smart script to a user. In some embodiments, the script creation system 118 may display the smart script through a user interface on a computing device.

Various embodiments of the present disclosure may be a system, a method, and/or a computer program product at any possible technical detail level of integration. The computer program product may include a computer readable storage medium (or mediums) having computer readable program instructions thereon for causing a processor to carry out aspects of the present disclosure.

For example, the functionality described herein may be performed as software instructions are executed by, and/or in response to software instructions being executed by, one or more hardware processors and/or any other suitable computing devices. The software instructions and/or other executable code may be read from a computer readable storage medium (or mediums).

The computer readable storage medium can be a tangible device that can retain and store data and/or instructions for use by an instruction execution device. The computer readable storage medium may be, for example, but is not limited to, an electronic storage device (including any volatile and/or non-volatile electronic storage devices), a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a solid state drive, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions (as also referred to herein as, for example, “code,” “instructions,” “module,” “application,” “software application,” and/or the like) for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. Computer readable program instructions may be callable from other instructions or from itself, and/or may be invoked in response to detected events or interrupts. Computer readable program instructions configured for execution on computing devices may be provided on a computer readable storage medium, and/or as a digital download (and may be originally stored in a compressed or installable format that requires installation, decompression or decryption prior to execution) that may then be stored on a computer readable storage medium. Such computer readable program instructions may be stored, partially or fully, on a memory device (e.g., a computer readable storage medium) of the executing computing device, for execution by the computing device. The computer readable program instructions may execute entirely on a user's computer (e.g., the executing computing device), in part on the user's computer, as a stand-alone software package, in part on the user's computer and in part on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart(s) and/or block diagram(s) block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks. For example, the instructions may initially be carried on a magnetic disk or solid state drive of a remote computer. The remote computer may load the instructions and/or modules into its dynamic memory and send the instructions over a telephone, cable, or optical line using a modem. A modem local to a server computing system may receive the data on the telephone/cable/optical line and use a converter device including the appropriate circuitry to place the data on a bus. The bus may carry the data to a memory, from which a processor may retrieve and execute the instructions. The instructions received by the memory may optionally be stored on a storage device (e.g., a solid state drive) either before or after execution by the computer processor.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. In addition, certain blocks may be omitted in some implementations. The methods and processes described herein are also not limited to any particular sequence, and the blocks or states relating thereto can be performed in other sequences that are appropriate.

It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. For example, any of the processes, methods, algorithms, elements, blocks, applications, or other functionality (or portions of functionality) described in the preceding sections may be embodied in, and/or fully or partially automated via, electronic hardware such application-specific processors (e.g., application-specific integrated circuits (ASICs)), programmable processors (e.g., field programmable gate arrays (FPGAs)), application-specific circuitry, and/or the like (any of which may also combine custom hard-wired logic, logic circuits, ASICs, FPGAs, etc. with custom programming/execution of software instructions to accomplish the techniques).

Any of the above-mentioned processors, and/or devices incorporating any of the above-mentioned processors, may be referred to herein as, for example, “computers,” “computer devices,” “computing devices,” “hardware computing devices,” “hardware processors,” “processing units,” and/or the like. Computing devices of the above-embodiments may generally (but not necessarily) be controlled and/or coordinated by operating system software, such as Mac OS, iOS, Android, Chrome OS, Windows OS (e.g., Windows XP, Windows Vista, Windows 7, Windows 8, Windows 10, Windows Server, etc.), Windows CE, Unix, Linux, SunOS, Solaris, Blackberry OS, VxWorks, or other suitable operating systems. In other embodiments, the computing devices may be controlled by a proprietary operating system. Conventional operating systems control and schedule computer processes for execution, perform memory management, provide file system, networking, I/O services, and provide a user interface functionality, such as a graphical user interface (“GUI”), among other things.

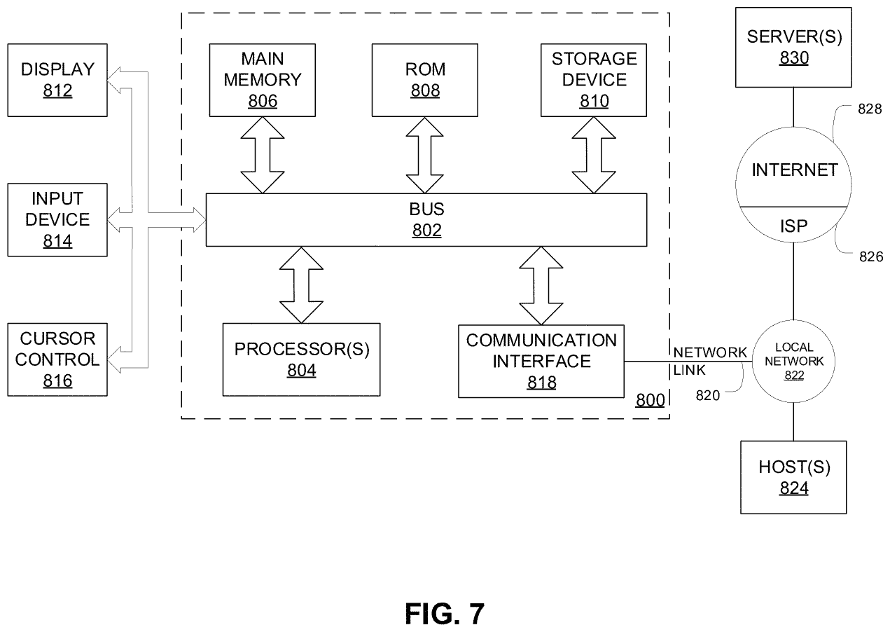

For example, FIG. 7 is a block diagram that illustrates a computer system 800 upon which various embodiments may be implemented. Computer system 800 includes a bus 802 or other communication mechanism for communicating information, and a hardware processor, or multiple processors, 804 coupled with bus 802 for processing information. Hardware processor(s) 804 may be, for example, one or more general purpose microprocessors.

Computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

Computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions.

Computer system 800 may be coupled via bus 802 to a display 812, such as a cathode ray tube (CRT) or LCD display (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

Computing system 800 may include a user interface module to implement a GUI that may be stored in a mass storage device as computer executable program instructions that are executed by the computing device(s). Computer system 800 may further, as described below, implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 804 executing one or more sequences of one or more computer readable program instructions contained in main memory 806. Such instructions may be read into main memory 806 from another storage medium, such as storage device 810. Execution of the sequences of instructions contained in main memory 806 causes processor(s) 804 to perform the process steps described herein. In alternative embodiments, hard-wired circuitry may be used in place of or in combination with software instructions.

Various forms of computer readable storage media may be involved in carrying one or more sequences of one or more computer readable program instructions to processor 804 for execution. For example, the instructions may initially be carried on a magnetic disk or solid state drive of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN (or WAN component to communicated with a WAN). Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

As described above, in various embodiments certain functionality may be accessible by a user through a web-based viewer (such as a web browser), or other suitable software program). In such implementations, the user interface may be generated by a server computing system and transmitted to a web browser of the user (e.g., running on the user's computing system). Alternatively, data (e.g., user interface data) necessary for generating the user interface may be provided by the server computing system to the browser, where the user interface may be generated (e.g., the user interface data may be executed by a browser accessing a web service and may be configured to render the user interfaces based on the user interface data). The user may then interact with the user interface through the web-browser. User interfaces of certain implementations may be accessible through one or more dedicated software applications. In certain embodiments, one or more of the computing devices and/or systems of the disclosure may include mobile computing devices, and user interfaces may be accessible through such mobile computing devices (for example, smartphones and/or tablets).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the systems and methods can be practiced in many ways. As is also stated above, it should be noted that the use of particular terminology when describing certain features or aspects of the systems and methods should not be taken to imply that the terminology is being re-defined herein to be restricted to including any specific characteristics of the features or aspects of the systems and methods with which that terminology is associated.

Conditional language, such as, among others, “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “substantially” when used in conjunction with the term “real-time” forms a phrase that will be readily understood by a person of ordinary skill in the art. For example, it is readily understood that such language will include speeds in which no or little delay or waiting is discernible, or where such delay is sufficiently short so as not to be disruptive, irritating, or otherwise vexing to a user.

Conjunctive language such as the phrase “at least one of X, Y, and Z,” or “at least one of X, Y, or Z,” unless specifically stated otherwise, is to be understood with the context as used in general to convey that an item, term, etc. may be either X, Y, or Z, or a combination thereof. For example, the term “or” is used in its inclusive sense (and not in its exclusive sense) so that when used, for example, to connect a list of elements, the term “or” means one, some, or all of the elements in the list. Thus, such conjunctive language is not generally intended to imply that certain embodiments require at least one of X, at least one of Y, and at least one of Z to each be present.

The term “a” as used herein should be given an inclusive rather than exclusive interpretation. For example, unless specifically noted, the term “a” should not be understood to mean “exactly one” or “one and only one”; instead, the term “a” means “one or more” or “at least one,” whether used in the claims or elsewhere in the specification and regardless of uses of quantifiers such as “at least one,” “one or more,” or “a plurality” elsewhere in the claims or specification.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

While the above detailed description has shown, described, and pointed out novel features as applied to various embodiments, it may be understood that various omissions, substitutions, and changes in the form and details of the devices or processes illustrated may be made without departing from the spirit of the disclosure. As may be recognized, certain embodiments of the inventions described herein may be embodied within a form that does not provide all of the features and benefits set forth herein, as some features may be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A system comprising:
a non-transitory computer-readable storage medium storing computer-executable instructions; and
one or more hardware processors in communication with the computer-readable memory, wherein the executable instructions, when executed by the one or more hardware processors, cause the one or more hardware processors to at least:
receive an electronic script file, wherein the electronic script file comprises a plurality of characters;
identify a plurality of script categories;
identify a coordinate location for each character in the electronic script file;
determine a script category for each character based at least in part on the coordinate location associated with each character;
assign a display format for each character, wherein the display format is based at least in part on the script category;
generate a smart script based at least in part on the display format; and
transmit the smart script to a user computing device.

2. The system of claim 1, wherein the plurality of script categories comprises dialogue, speech, exposition, and location categories.

3. The system of claim 1, wherein electronic script file is stored in a searchable electronic format.

4. The system of claim 1, wherein each page of the electronic script file is associated with an x-y coordinate system.

5. The system of claim 4, wherein the top-left corner of each page of the electronic script file is associated with a (0, 0) x-y coordinate location.

6. The system of claim 1, wherein the coordinate location for each character in the electronic script file comprises a unique coordinate in an x-y coordinate system.

7. The system of claim 1, wherein the script category for each character is further determined based at least in part on the identity of the character and a specific sequence of characters.

8. The system of claim 1, wherein the display format for each character comprises an image associated with the script category for the character.

9. The system of claim 1, wherein the display format for each character is based at least in part on the coordinate location and the script category associated with the character.

10. The system of claim 1, wherein the smart script displays text according to the coordinate location associated with each character and generates images associated with text.

11. A computer-implemented method comprising:
under control of one or more computing devices executing specific computer-executable instructions,
receiving an electronic script file, wherein the electronic script file comprises a plurality of characters;
identifying a plurality of script categories;
identifying a coordinate location for each character in the electronic script file;
determining a script category for each character based at least in part on the coordinate location associated with each character;
assigning a display format for each character, wherein the display format is based at least in part on the script category;
generating a smart script based at least in part on the display format; and
transmitting the smart script to a user computing device.

12. The computer-implemented method of claim 11, wherein the plurality of script categories comprises dialogue, speech, exposition, and location categories.

13. The computer-implemented method of claim 11, wherein electronic script file is stored in a searchable electronic format.

14. The computer-implemented method of claim 11, wherein each page of the electronic script file is associated with an x-y coordinate system.

15. The computer-implemented method of claim 14, wherein the top-left corner of each page of the electronic script file is associated with a (0, 0) x-y coordinate location.

16. The computer-implemented method of claim 11, wherein the coordinate location for each character in the electronic script file comprises a unique coordinate in an x-y coordinate system.

17. The computer-implemented method of claim 11, wherein determining the script category for each character is based at least in part on the identity of the character and a specific sequence of characters.

18. The computer-implemented method of claim 11, wherein the display format for each character comprises an image associated with the script category for the character.

19. The computer-implemented method of claim 11, wherein the display format for each character is based at least in part on the coordinate location and the script category associated with the character.

20. The computer-implemented method of claim 11, wherein the smart script displays text according to the coordinate location associated with each character and generates images associated with text.
